(19) United States
(12) Patent Application Publication
(10) Pub. No.: US 2011/0247467 A1
(43) Pub. Date: Oct. 13, 2011

(54) HEAVY-DUTY PUNCH TECHNOLOGY

(75) Inventor: Paul T. Johnson, Stillwater, MN (US)

(73) Assignee: WILSON TOOL INTERNATIONAL INC., White Bear Lake, MN (US)

(21) Appl. No.: 13/085,011

(22) Filed: Apr. 12, 2011

Related U.S. Application Data
(60) Provisional application No. 61/323,112, filed on Apr. 12, 2010.

(51) Int. Cl. B26F 1/44; B26F 1/14

(52) U.S. Cl. 83/13; 83/686

(57) ABSTRACT

Heavy-duty, wear-resistant punches and punch blanks for stamping are derived from cold work steel formed by powder metallurgy processing and containing not greater than about 4% of tungsten. The punches and blanks desirably contain not greater than about 4% molybdenum by weight and at least about 5% chromium by weight. Related stamping method are also disclosed.

### CROSS REFERENCE TO RELATED APPLICATIONS

This application is a non-provisional application of U.S. Serial No. 61/323,112, filed Apr. 12, 2010, the entire disclosure of which is incorporated herein by reference.

### FIELD OF THE INVENTION

The invention relates to punches used in stamping operations, and particularly to punches designed for heavy duty use.

### BACKGROUND OF THE INVENTION

In the fabricating industry, punches and dies are used to appropriately pierce workpieces of metal and other materials, the dies having openings for the reception of tips of the punches during a punching operation. Thus, the punches and dies are subjected to substantial and repeated stresses. As the tips of punches are forced under high loads through the thicknesses of work pieces and into the die openings, they experience substantial forces. After enough use, punches may fail through breakage. Or, because normally sharp edges of the punch tips become worn through repeated usage and regrinding, the punches may become unusable. Further, as a result of such repeated use and corresponding wear, the punches can become prone to breakage failure. For example, in the case of headed punches, the head of the punch can actually break off from the body of the punch due to stresses experienced by the punch. As detailed below, these effects have been known to occur particularly in the case of punches used in stamping applications.

Accordingly, toughness and wear-resistance are two desired qualities for punches, and this is particularly true for punches intended for heavy duty use (i.e., heavy-duty punches), such as those used in stamping applications. Heavy-duty punches can be standard type, headed type or ball lock type and are used, for example, in certain progressive stamping operations. Contrary to turret operations (which generally involve a period of nonuse for each of the utilized punches) or press brake operations (which typically involve non-heavy duty machining), stamping operations are commonly carried out with a single tool set being continuously used in a heavy duty manner (i.e., on workpieces of heavy material). Because the workpieces generally involve the same type and thickness of material, stamping punches and dies to date are generally selected to have the necessary properties of durability and wear resistance for that particular grade or type of workpiece. To that end, for heavy duty operations (e.g., when working with heavy material), the punches desirably have increased durability and wear resistance so as to enable them to be successfully used with the workpieces to be encountered. However, given the continuous use of the punches in such a heavy duty manner, finding a material that is suitable for such long-term manner of use has become increasingly difficult.

Classifications of tool steels include high speed steels and cold work steels, and punches have been manufactured from both of these tool steel types. Tools derived from high speed steels commonly can operate at high temperatures, e.g., up to about 700-1200° F., and possess good “red hardness”. High speed steels generally contain 3% to 5% chromium and greater than 5% and up to 18% or more of tungsten, the tungsten component contributing to high temperature properties. High speed steels are commonly used for making drills, punches, routers, taps, etc. Cold work steels, on the other hand, commonly contain less tungsten, e.g., not more than about 4% and often less than 2%, and are used for making tools such as burnishing and coining tools and shear blades. Cold work steels do not have the red hardness properties that permit high temperature use. Unless otherwise indicated, the percentages of the various elements are given by weight.

A problem with conventional steels involves the formation of carbides due to the inclusion of carbon and various alloying metals such as chromium, vanadium, and tungsten in steel formulations. Carbon reacts with various alloying elements in a steel-making furnace to form metal carbides. The resulting metal carbides are uniformly distributed in the melt, but as the melt solidifies, carbide particles form and tend to clump or aggregate together. When the resulting material is subsequently worked, as in a roller mill, the carbide agglomerates may line up in the direction of work, forming what are commonly known as carbide “stringers.” Carbides generally are very hard and somewhat brittle materials, vanadium carbide and tungsten carbide being among the hardest. When tool steel blanks are machined to make tools such as punches, the carbide stringers not only make the steel alloy blanks difficult to work with, but also tend to provide fracture lines along which the resulting tool materials may fracture during subsequent use. Microscopically, high carbon steels commonly exhibit a grain structure in which the carbide stringers show up prominently.

Powder metallurgy makes use of a different process of forming tool steel alloys. The melt, containing molten iron, carbon, and various alloying elements such as vanadium, chromium and molybdenum, is formed in the usual way. Thereafter, however, the molten material is atomized—that is, it is formed in a known manner into small droplets. Each of the resulting droplets or particles, then, has the same composition as the melt from which it came, that is, each particle has the same atomic make up; it is its own “ingot.” Particles are then placed in a canister and are subjected to intense pressures at temperatures below the melting points of the metals. The particles fuse together without melting to form ingots. Since the melt is not permitted to solidify by itself (which otherwise could give rise to carbide stringers), the resulting powder metallurgy ingot is very uniform in composition, and the carbide portions are contained in the ingot in a very evenly distributed fashion without evidence of stringers.

As a result, powder metallurgy techniques enable alloys of various types to be manufactured that could not be manufactured through routine steel making processes. For example, in routine steel making, it is difficult to obtain a carbide volume concentration greater than about 20%, whereas carbide concentrations up to 30% are not uncommon in powder metallurgy materials.

Punches have in the past been formed from high speed steel blanks resulting from powder metallurgy processing, but, as alluded to above, some have not exhibited the necessary combination of toughness and wear resistance over long-term use. Moreover, it is believed that heavy-duty punches for stamping have not been formed of the most advantageous powder metallurgy materials. Toughness involves the ability of a punch to absorb repeated impacts without breaking Wear resistance, as the term implies, involves how much a punch wears upon repeated use. It is commonly understood that harder materials have greater wear resistance. However, harder materials also tend to exhibit greater brittleness, which may lead to reduced toughness and a greater propensity of punches and dies to shatter catastrophically.

### BRIEF DESCRIPTION OF THE DRAWINGS

FIG. 1 is an isometric view of a heavy-duty punch blank formed of a desired powder metallurgy steel in accordance with an embodiment of the present invention.

FIG. 2 is a side view of the heavy-duty punch blank of FIG. 1.

FIG. 3 is an isometric view of a heavy-duty punch formed of a desired powder metallurgy steel in accordance with another embodiment of the invention.

FIG. 4 is a side view of the heavy-duty punch of FIG. 3.

FIG. 5 is a group of isometric partial views of a heavy-duty punch formed of a desired powder metallurgy steel in accordance with a further embodiment of the invention.

FIG. 6 is a group of side and upper views of the heavy-duty punch of FIG. 5.

### DETAILED DESCRIPTION OF PREFERRED EMBODIMENTS OF THE INVENTION

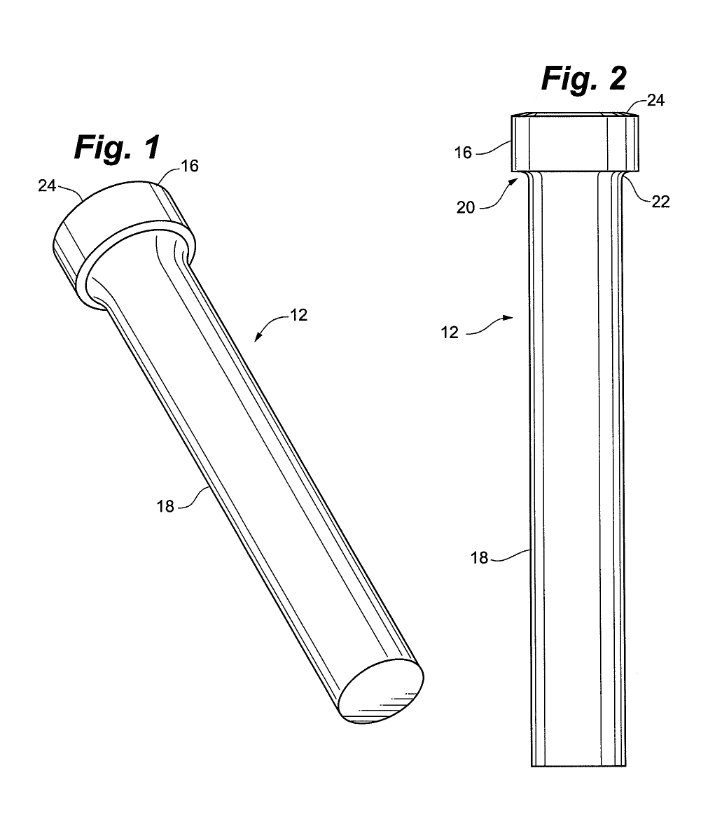

The present invention provides heavy-duty punches for use in heavy duty stamping operations. The heavy-duty punches are derived from powder metallurgy processes, as detailed herein, and consequently, have been found to exhibit a combination of excellent wear resistance and toughness when used in such stamping operations. In particular, the punches direct stamping forces through the punch shank and away from the punch edges. The excellent wear resistance and toughness properties of the heavy-duty punch not only relate back to the powder metallurgy processes used in forming the punch, but also to the overall punch design as used with stamping equipment. The punches used with stamping equipment can be the well known standard type, headed type, or ball lock type. As illustrated in FIGS. 1-6, these punch designs each involve a single integral piece (e.g., of metal). That is, the punch consists of (or at least consists essentially of) a single metal piece.

For example, a punch design of the headed type is illustrated in FIGS. 1-4, with punch blank 12 and corresponding punch 14 being shown. Each of the punch blank 12 and punch 14 includes (or consists of) a head portion 16 and body portion 18, between which lies a radius portion 20. In certain embodiments, the radius portion 20 has an expanded circumference extending from the body portion 18 to the head portion 16. For example, the radius portion 20 preferably has a diameter (as measured in a plane perpendicular to the long central axis of the punch) that increases gradually in moving from the body portion 18 to the head portion 16. In certain embodiments, the under head radius 22 (measured in a plane parallel to, and lying on, the long central axis of the punch) at the radius portion 20 is between about 0.02 inch and about 0.1 inch, and in certain commercial embodiments, is between about 0.045 inch and about 0.055 inch. When provided as such in combination with use of the powder metallurgy processes described herein, the radius portion 20 is found to exhibit enhanced strength. As a result, resistance is provided to the head portion 16 breaking off the body portion 18 due to stresses experienced—known to be the most common cause of head failure when stamping heavy gauge and high tensile material. The present tool design substantially eliminates head breakage. In order to further enhance the strength of the headed punch type, parameters of the head portion 16 can optionally be modified. For example, in certain embodiments, the head portion 16 is formed with a thickness of at least about 0.3 inch, and perhaps more preferably, at least about 0.31 inch. Further, the upper end of the head portion 16 can optionally have a taper 24 (measured from the planar top surface of the punch head). Preferably, the taper 24 is at least about 5°, and in certain commercial embodiments, it is at least about 7.5°, such as about 10°. Additionally or alternatively, the taper 24 results in an uppermost end of the head portion 16 having a diameter equal to (or at least substantially equal to) the diameter of the body portion 18.

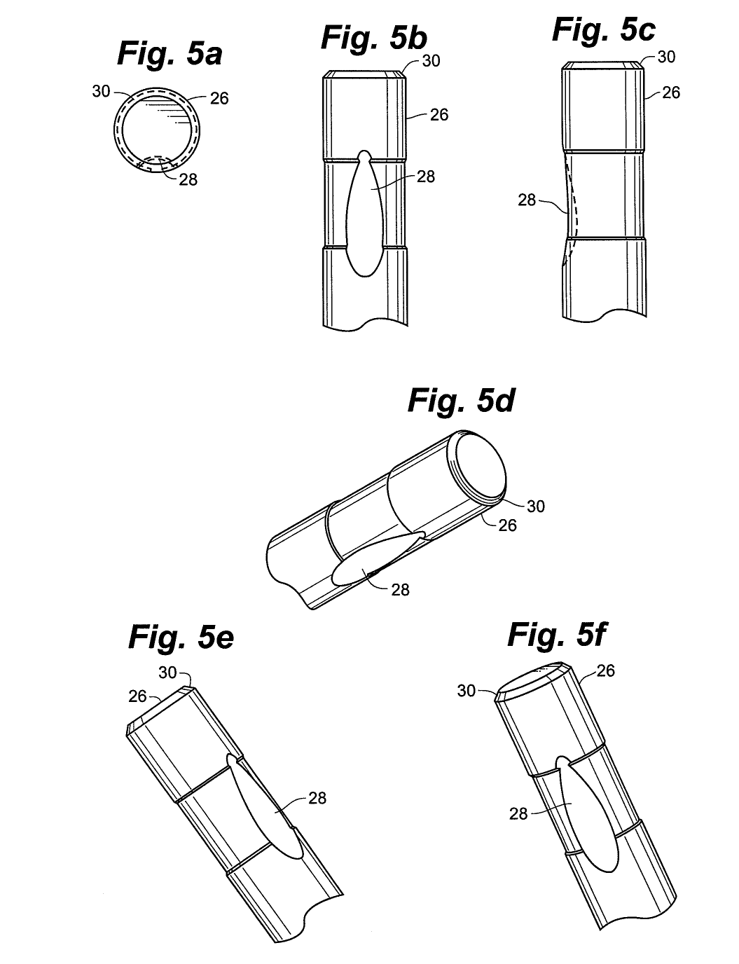

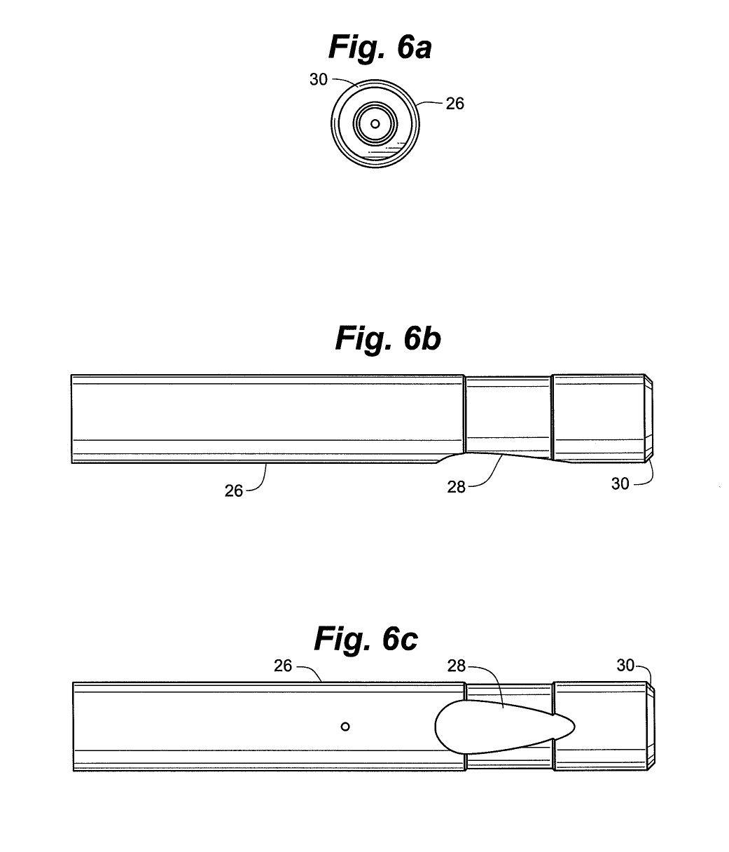

Further exemplified in FIGS. 5 and 6 are punch designs of the ball lock type. A punch blank 26 is shown for this punch type, partial views of which are illustrated in FIG. 5 and whole views of which are illustrated in FIG. 6. As shown, each blank 26 includes a recess (or “dimple”) 28 for mating with a corresponding ball-locking member (not shown). The illustrated recess 28 has a generally oval-shaped configuration, although this is not strictly required. Similar to that described above with respect to the headed punch type, the upper end of the ball lock punch can further have a taper 30, shown in FIGS. 5 and 6. In certain commercial embodiments, such taper 30 is about 12°, although the taper angle can be within any one or more of the taper angle ranges taught above.

Each of the punch types (standard type, headed type, or ball lock type) used in stamping operations is streamlined in comparison to punches used in other workpiece-machining equipment. For example, in a turret design, the punch design further includes other corresponding elements, such as a guide, spring pack, and driver. In forming the present punch of a single integral piece, the punch is particularly durable, which is advantageous given the heavy duty machining operations intended for the present stamping punch. Consequently, the heavy-duty punch not only holds up better during continuous operations of this sort, but also better withstands long-term stamping use.

In one embodiment, this invention provides a heavy-duty punch or punch blank for use in heavy duty stamping operations, the punch or blank having a body derived from cold work tool steel formed by powder metallurgy processing and containing not greater than about 4% tungsten by weight, and preferably not greater than about 2% tungsten by weight. This type of powder metal can advantageously be used for any punch embodiment of the present disclosure.

In another embodiment, the invention provides a durable, wear-resistant punch or punch blank for use in heavy duty stamping operations, the punch or blank having a body derived from cold work tool steel formed by powder metallurgy processing and containing from about 0.2% to about 4% (and preferably from about 0.5% to about 2%) of tungsten by weight and, preferably, containing from about 5% to about 10% (and most preferably from about 7% to about 9%) of chromium by weight. Here again, this type of powder metal can be used for any punch of the present disclosure.

In another embodiment, the invention relates to a method of forming a metal workpiece on a punch press, comprising providing a heavy-duty punch in the punch press, the punch having a body derived from cold work tool steel formed by powder metallurgy processing and comprising not greater than about 4% of tungsten by weight, and performing a stamping operation (optionally a progressive stamping operation) using the heavy-duty punch. Preferably, the method includes providing and using a die with the punch. The punch used in the present method can have the features (e.g., powder metal composition, dimensions, and shape) described in any punch embodiment of the present disclosure.

In a preferred embodiment, the invention provides a durable, wear-resistant punch or punch blank having a body derived from cold work tool steel formed by powder metallurgy processing and containing tungsten in an amount not greater than about 2% by weight, at least about 7% (and preferably at least about 7.3%) chromium by weight, and not more than about 2% molybdenum by weight. This type of powder metal can be used for any punch of the present disclosure.

Desirably, the present cold work, powder metallurgy-derived steels contain, independently or in combination, from about 0.9% to about 3% (preferably about 1.5 to about 2%) by weight of carbon, from about 5% to about 10% (preferably from about 7% to about 9%) by weight of chromium, from about 1% to about 4% (preferably about 1% to about 2%) by weight of molybdenum, and about 2% to about 6% (preferably about 1% to about 2%) by weight of vanadium. This particular powder metal can be used for any punch of the present disclosure.

Although the invention is particularly desirable in connection with heavy-duty punches, and especially heavy-duty punches used in stamping environments, it may in some instances be desirable to manufacture not only the punch but also the die from these powder metallurgy materials.

As used herein, “hardness” commonly is measured on the Rockwell C scale, with

Rockwell C values in the range of about 50 to about 70 (such as about 58 to about 62 in certain commercial embodiments) being desired for the present punches and punch blanks

“Toughness,” as used herein, refers to how well a punch can resist breakage when subjected to substantial loads; one measure of toughness appropriate for punches is compressive strength. Punches must resist repeated high loads without breaking

Wear resistance is measured by actually measuring the distance a surface wears when subjected to wear-producing forces, this surface commonly being the cutting edge of the punch tip.

One punch of the invention would be manufactured by machining the punch blank from a cold work tool steel blank formed by powder metallurgy from a melt containing 1.1% carbon and 7.75% Cr, the melt containing 1.10% by weight of tungsten and the blank being designated “A” in the following tables. Other exemplary compositions (in percent by weight) are given in Table I below, it being understood that there may be included trace amounts of other materials as well.

TABLE I

| Tool Steel | C | Cr | Mo | V | W | S | Si | Mn |
|---|---|---|---|---|---|---|---|---|
| A | 1.10 | 7.75 | 1.60 | 2.35 | 1.10 | | 1.2 | 0.25 |
| B | 0.80 | 7.50 | 1.30 | 2.75 | | | | |
| C | 1.42 | 7.57 | 1.28 | 3.71 | 1.75 | | 1.17 | 0.29 |
| D | 1.79 | 7.61 | 1.30 | 5.73 | 1.74 | 0.12 | 1.24 | 0.41 |

For ball lock type punches, the round cold worked steel bar is turned in a lathe to a dimension slightly larger than the required finished outside diameter (OD) of the part and to a specified length for the part. The blank is then heat treated to appropriate hardness and ground on the outside diameter OD to a finished tolerance. Once the finished outside diameter OD is to specification, the teardrop recess (used to lock the punch in the die plate) is either ground or milled into the side of the punch and a tip shape or specified round dimension is ground onto the working end of the punch. Headed punches are manufactured with a similar process but prior to heat treating, the head end of the punch is induction heated and a hydraulic form is used to deform the end of the punch into the headed shape. This head form process is preferred to other methods since the structure of the material remains stronger. Suitable powder metal steel blanks can be obtained commercially from Bohler-Uddeholm Corporation of Elgin, Ill., USA, or from ThyssenKrupp Steel USA, LLC of Calvert, Ala., USA.

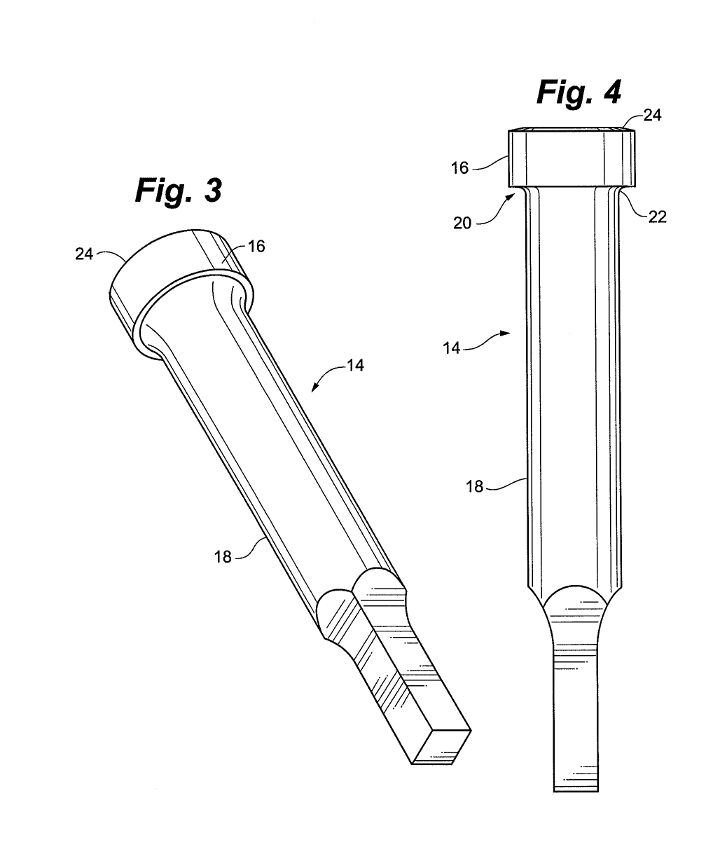

FIGS. 1 and 2 depict a punch blank formed of the desired powder metallurgy cold work steel. Here, the punch will have a circular tip. FIGS. 3 and 4 show a heavy-duty punch that has a square tip and is formed of the desired powder metallurgy cold work steel. The punch tip, of course, can be provided in many different shapes, depending on the shape of the hole to be punched.

In some of the present embodiments, the punch blank and the resulting punch have an enlarged head. This head is integral to the rest of the punch blank or punch and is formed of the same powder metallurgy cold work steel. The punch, however, can be of the standard type, headed type, or ball lock type, as noted above. Thus, the punch may or may not have an enlarged head, depending on the punch style.

In some embodiments, the punch blank or punch is a single body formed of (e.g., consisting of or consisting essentially of) the desired powder metallurgy cold work steel. As already explained, when the punch is of the headed type, a radius preferably is provided between the enlarged head and the punch shank, as is best seen in FIGS. 2 and 4.

In side by side testing, the powder metallurgy cold work steel embodied herein demonstrates surprisingly superior performance over other materials typically used in heavy-duty stamping applications. The other tested materials involved PM-M4, generally known as a super high-speed steel having a very high carbon and vanadium content for exceptional abrasion resistance, and M2, generally known as a high-speed steel in tungsten-molybdenum series. During these side-by-side tests, the powder metallurgy cold work steel embodied herein demonstrated 86% greater toughness than the M2 steel and 11% greater toughness than the PM-M4 steel. During the tests, the cold work steel further demonstrated 64% greater wear resistance than the M2 steel and 25% greater wear resistance than the PM-M4 steel.

While a preferred embodiment of the present invention has been described, it should be understood that various changes, adaptations and modifications may be made therein without departing from the spirit of the invention and the scope of the appended claims.

What is claimed is:

1. A durable, wear-resistant punch for use in stamping applications, the punch being a single integral piece, the single integral piece derived from cold work tool steel formed by powder metallurgy processing and containing not greater than about 2% of tungsten by weight.

2. The punch of claim 1 wherein the punch is a standard type punch, a headed type punch, or a ball-lock type punch.

3. The punch of claim 1 wherein the punch is a headed type punch, wherein the single integral piece comprises a radius portion lying between a head portion and a body portion, and wherein the radius portion has an expanded circumference extending from the body portion to the head portion.

4. The punch of claim 3 wherein the radius portion has an under head radius between about 0.045 inch and about 0.055 inch.

5. The punch of claim 1 wherein said tool steel contains from about 0.5% to about 2% of tungsten by weight.

6. The punch of claim 5 wherein said tool steel contains about 7% or greater of chromium by weight.

7. The punch of claim 6 wherein said tool steel contains from about 7% to about 9% of chromium by weight.

8. The punch of claim 6 wherein said tool steel contains not greater than about 2% of molybdenum by weight.

9. The punch of claim 8 wherein said tool steel contains from about 1% to about 2% of molybdenum by weight.

10. The punch of claim 8 wherein said tool steel contains from about 0.9% to about 3% of carbon by weight.

11. The punch of claim 10 wherein said tool steel contains from about 2% to about 6% of vanadium by weight.

12. A method of forming a metal workpiece on a stamping press, the method comprising:
providing a punch in said stamping press, the punch being a single integral piece, the single integral piece derived from cold work tool steel formed by powder metallurgy processing and containing not greater than about 2% of tungsten by weight; and
performing a stamping operation on the workpiece using the punch.

13. The method of claim 12 wherein the punch is a headed type punch, wherein the single integral piece comprises a radius portion lying between a head portion and a body portion, the radius portion having an expanded circumference extending from the body portion to the head portion, thereby providing resistance to the head portion from breaking off of the punch due to stresses experienced by the punch during the stamping operation.

14. The method of claim 13 wherein the radius portion has an under head radius between about 0.045 inch and about 0.055 inch.

15. The method of claim 12 wherein said tool steel contains from about 0.5% to about 2% of tungsten by weight.

16. The method of claim 15 wherein said tool steel contains about 7% or greater of chromium by weight.

17. The method of claim 16 wherein said tool steel contains not greater than about 2% of molybdenum by weight.

18. A durable, wear-resistant punch for use in stamping applications, the punch being a single integral piece, the single integral piece derived from cold work tool steel formed by powder metallurgy processing and containing from about 0.5% to about 2% of tungsten by weight, from about 7% to about 9% of chromium by weight, and from about 1% to about 2% of molybdenum by weight, the punch being a headed type punch, wherein the single integral piece comprises a radius portion lying between a head portion and a body portion, and wherein the radius portion has an expanded circumference extending from the body portion to the head portion.

19. The punch of claim 18 wherein the radius portion has an under head radius between about 0.045 inch and about 0.055 inch.

20. The punch of claim 19 wherein an upper end of the head portion has a taper that is greater than about 5°.

21. The punch of claim 20 wherein the taper results in an uppermost end of the head portion having a diameter substantially equal to a diameter of the body portion.
